(19) United States
(12) Patent Application Publication
(10) Pub. No.: US 2007/0184214 A1
(43) Pub. Date: Aug. 9, 2007

(54) METHOD OF AND APPARATUS FOR PRINTING DIGITALLY IMAGED SIGNS

(75) Inventors: Scott A. Boyd, White Bear Lake, MN (US); Billy Lee Weaver, Eagan, MN (US); Michael Benton Free, Saint Paul, MN (US); Daniel W. Hennen, Cottage Grove, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/670,719

(22) Filed: Feb. 2, 2007

Related U.S. Application Data
(60) Provisional application No. 60/743,225, filed on Feb. 3, 2006.

(51) Int. Cl. B44F 1/10; B05D 5/00; B32B 1/00; B32B 3/00

(52) U.S. Cl. 428/29; 427/256; 428/187; 428/195.1; 428/206; 428/207

(57) ABSTRACT

Various methods and fluid delivery systems are described for printing digitally imaged signs. One method of applying pigmented material to a print medium involves using a fluid delivery system to coat at least a portion of an exterior surface of a cable with a pigmented material and then placing the coated portion of the cable in close proximity to the print medium. An air stream is then directed at the portion of the cable coated with the pigmented material such that a the pigmented material is removed from the exterior surface of the cable and is deposited onto the print medium.

### RELATED APPLICATION

This application derives priority from U.S. Provisional Patent Application No. 60/743,225, filed Feb. 3, 2006.

### TECHNICAL FIELD

This patent application relates to various types of signage and methods of printing various types of signage.

### BACKGROUND

Signs are commonly used along roadways to display information to motor vehicle drivers and pedestrians. One type of sign, a highway sign, typically includes reflective or retroreflective sheeting that has characters printed or placed thereon. The characters provide information that is of interest to the motor vehicle drivers or pedestrians, and the retroreflective sheeting allows the information to be vividly displayed at nighttime. Retroreflective sheeting has the ability to return a substantial portion of incident light in the direction from which the light originated. Light from motor vehicle headlamps is retroreflected by the signs, allowing the information to be read more easily by passing motorists and pedestrians.

Many types of signs, including highway signs, tend to be fairly large in size to accommodate large characters. The characters are typically applied to the signs by screen printing or using cut-out characters. In screen printing, a positive or negative image of the characters is first provided on a screen. This often is accomplished by exposing non-masked portions of a photosensitive screen to light and removing the un-sensitized, masked regions by scrubbing. Ink is then forced through the openings in the screen where the photosensitive material was removed and onto the retroreflective sheeting. Screen printing is the method of choice for making the more common street signs, such as “stop” and “yield” signs. However, screen printing custom or unique signs (such as, for example, highway and road signs) is costly and inefficient because a separate screen needs to be made for each individual sign.

When a custom or unique sign is needed, the cut-out character method is frequently used. Cut-out characters are made by die cutting each character or by electronically cutting the characters from a stock material such as, for example, Scotchcal™ ElectroCut™ Graphic Films manufactured by 3M Company of St. Paul, Minn. The cut-out characters typically are secured to the underlying retroreflective sheeting by use of an adhesive. Although the screen printing and cut-out character methods provide suitable ways of placing characters on highway signs, these methods tend to be time-consuming and somewhat cumbersome.

Thermal printing has become a popular and commercially successful technique for forming characters on a substrate. Also referred to as thermal transfer printing, non-impact printing, thermal graphic printing, and thermography, thermal printing is a process by which a colorant is transferred with the aid of heat from a carrier to a thermal print receptive substrate. Thermal printing is more rapid than screen printing or using cut-out characters, and it is less cumbersome and relatively simple to practice.

While thermal printing provides a rapid means for placing information on reflective or retroreflective sheeting, this printing method also has its drawbacks. Perhaps the biggest drawback is the cost of the ribbon, which is technically pre-dried ink that comes along with a thin polyester carrier. Ribbon is used at a relatively high rate in an area equal to the area of the entire sign, not just the legend portion of the sign. All of the polyester carrier portion of the ribbon becomes waste and any ink not transferred to the sign also becomes waste.

Another drawback is that known thermal printing apparatuses are unable to handle large-sized sheetings. Presently known thermal printing apparatuses generally are unable to print on sheeting having a size that is greater than 90 cm wide. Consequently, when a sign larger than 90 cm wide is desired, separate sheets must be thermally printed and those sheets must be subsequently joined together to produce a complete sign.

Another disadvantage of known thermal printing systems is that the wide ribbon in the printing system has a tendency to wrinkle, causing an uneven transfer of colorant and poor quality graphic resolution. Further, known systems do not use the ribbon in a very efficient manner. Thermal printing in a region having a width that is less than the width of the substrate onto which the printer is printing results in using only the portion of the ribbon corresponding to the width of the printed image. The unused portion of the ribbon becomes discarded with the used portion and therefore results in unnecessary waste. Additionally, thermal transfer printing preferably involves the use of a topcoat, increasing the cost of the resulting article.

Further, digitally printing signs for use outdoors has been challenging because most outdoor signs require the use of highly durable inks. Most highly durable inks have high viscosities. No prior art digital printing system has the ability to efficiently and effectively print with these high durability, high viscosity inks.

### SUMMARY

The present application is directed to methods of printing various types of signage, including signs and license plates. The methods are more efficient and cost effective than prior art methods of printing signs. The present application is also directed to various types of signage printed using these methods and to various types of apparatuses for printing these types of signage.

Some embodiments of the present application relate to methods of forming an image on signage comprising applying a pigmented material to at least a portion of an elongate structure; positioning the elongate structure in proximity to a substrate; and directing a fluid stream at the portion of the elongate structure to which the pigmented material was applied such that at least a portion of the pigmented material is deposited onto the substrate to thereby form the signage. Other embodiments of the present application relate to signage made by these methods.

Other embodiments of the present application relate to methods of digitally printing an image on signage comprising coating at least a portion of a wire-like member with a pigmented material; positioning the wire-like member in proximity to a substrate; and directing a fluid stream at the coated portion of the wire-like member such that at least a portion of the pigmented material is removed from the wire-like structure and is deposited onto the substrate to thereby form a pattern on the substrate. Other embodiments of the present application relate to signage made by these methods.

Another embodiment of the present application relates to signage comprising an optically active sheeting; and a pigmented material having a viscosity at ambient or room temperature (approximately 25 degrees Celsius) of between about 1 cP and about 2000 cP that is digitally printed on at least a portion of the sheeting to form an image. Exemplary signage may include a word, a letter, a symbol, a picture, a schematic, an image, a number, or a combination or variation thereof. Further, in some embodiments, the signage is capable of outdoor use and exhibits good durability and weatherability.

### BRIEF DESCRIPTION OF DRAWINGS

FIG. 1 is a perspective view of one embodiment of a fluid delivery system.

FIG. 2 is a side view of the fluid delivery system of FIG. 1.

FIG. 3 is a front view of an alternative embodiment of a fluid delivery system.

FIG. 4 is a side view of the fluid delivery system of FIG. 3.

FIG. 5 is a schematic view of one exemplary embodiment of a fluid delivery system including holes positioned adjacent to an orifice and a set of doctor blades.

FIG. 6 is a scanned image of signage printed using a fluid delivery system of the type described herein.

FIG. 7 is a scanned image of signage printed using a fluid delivery system of the type described herein.

FIG. 8 is a scanned image of signage printed using a fluid delivery system of the type described herein.

FIGS. 9a and 9b are, respectively, a schematic view and a scanned image of signage printed using a fluid delivery system of the type described herein.

FIGS. 10a and 10b are, respectively, a schematic view and a scanned image of signage printed using a fluid delivery system of the type described herein.

FIGS. 11a and 11b are, respectively, a schematic view and a scanned image of signage printed using a fluid delivery system of the type described herein.

### DETAILED DESCRIPTION

As used herein, the terms “elongate structure,” “cable,” “wire,” or “wire-like member” are used interchangeably and are meant to include a wire, a cable, multiple wires, a rope, a cord, a string, a strand, a rod, a saw tooth wheel, or combinations or variations thereof.

As used herein, the term “pigmented material” is meant to include all colored (or non-colored) inks, dyes, paints, or combinations or variations thereof.

As used herein, the term “print medium” and “substrate” are used interchangeably and are meant to include any print medium or substrate known in the art, including but not limited to paper, plastic, polymer, synthetic paper, metal foil, vinyl, non-woven materials, cloth, glass, wood, cement, metal, films, optical sheeting, and combinations or variations thereof. The print medium or substrate can be, for example, a rigid, pliable, or flexible material.

As used herein, the term “signage” is meant to include signs (including outdoor signs (e.g., highway signs, street signs, etc) and indoor signs, for example, building interior signing (e.g., fire exit signage, fire extinguisher signage, and the like), off-street signs (including, for example, parking lot signage, no parking signage, fire lane signage, and the like), license plates, billboards, and truck siding.

As used herein, the terms “fluid delivery system,” “printer,” “paint injector,” or variations or combinations thereof are used interchangeably.

Some preferred fluid delivery systems comprise (1) immersing an elongate structure in a reservoir of pigmented material for a period of time sufficient to allow the elongate structure to be coated with the pigmented material, (2) placing the coated elongate structure in proximity to a designated print medium onto which the pigmented material will be applied, and (3) directing a stream of fluid to contact the coated elongate structure and to thereby cause at least some of the pigmented material on the elongate structure to be transferred and deposited onto the designated print medium; and (4) move the fluid delivery system and/or the print medium in a controlled manner to form an image.

In some embodiments, the speed of the cable and the force/pressure of the fluid stream and/or the movement of the fluid delivery system or substrate may be digitally or electronically controlled by a processor, controller, microprocessor, or other computing device to ensure that a desired image resolution is achieved. Because the fluid delivery system is free of most of the mechanical limitations of traditional ink jet print heads, the system is compatible with application of high viscosity inks. When compared to the traditional coating apparatuses for high viscosity inks, the fluid delivery system allows controlled delivery, both in terms of location of an image or indicia on the print medium and drop size (and thus coating weight). The fluid delivery system thus allows for greater positional and coating weight control of high viscosity inks on the print medium or substrate. U.S. Pat. Nos. 5,944,893; 5,972,111; 6,089,160; 6,090,445; 6,190,454; 6,319,555; 6,398,869; and 6,786,971 describe this printer technology in greater detail and are incorporated herein by reference.

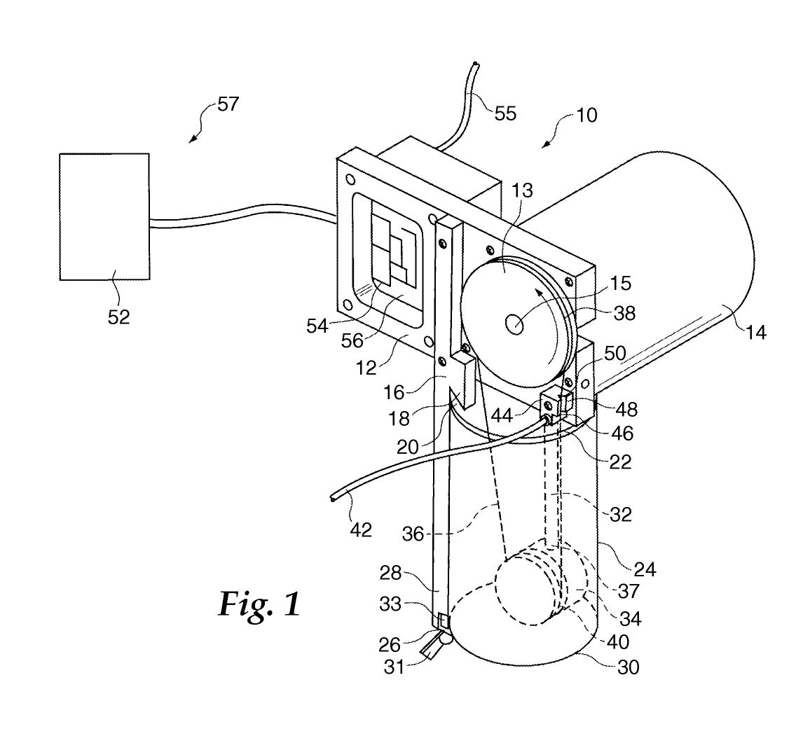

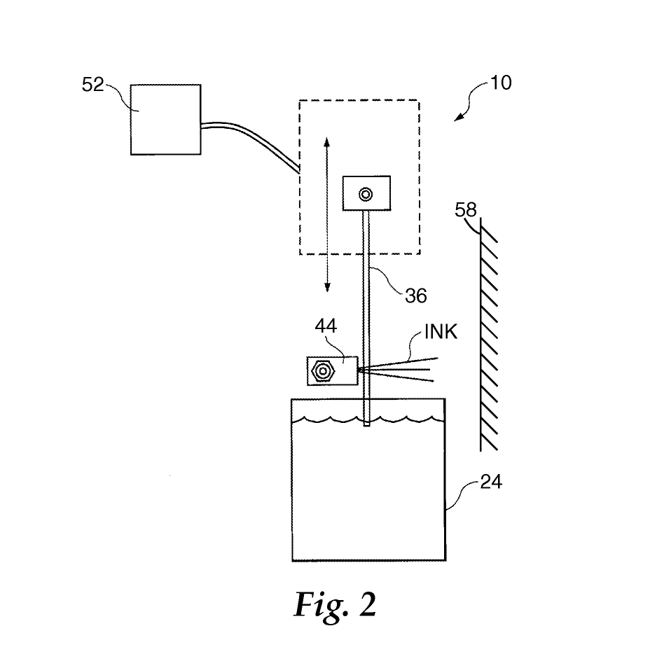

FIG. 1 is a perspective view of one embodiment of a fluid delivery system of the type described above, generally indicated at 10. FIG. 2 is a side view of the fluid delivery system of FIG. 1. A pulley 13 having a circumscribing groove 38 defined therein is secured to a shaft 15 of a motor 14. An elongate frame member 32 depends from and is secured to plate 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a continuous loop of cable 36, can slide during rotation of wheel 13. Cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of the ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate to nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate.

Rotation of shaft 15 may be controlled by a controller, generally indicated at 57. Any type of controller may be used. In one embodiment, the controller includes circuitry 54 in a module 56 that receives signals from a signal generating device 52, such as a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink contained in reservoir 24 is picked up by cable 36 and advanced by rotation of wheel 13, indicated by the arrow, in front of nozzle orifice 46. Air that is blown through nozzle orifice 46 disperses or pulls or directs the ink from cable 36 toward the print medium 58. Depending on the viscosity of the ink in the reservoir, the cross-sectional diameter of cable 36, and the diameter of wheel 13, a relatively precise amount of ink can be dispensed onto the print medium. Further, because the ink to be dispensed does not pass through a nozzle, the percent solids and/or the viscosity of the ink can be greater than the prior art printers permitted.

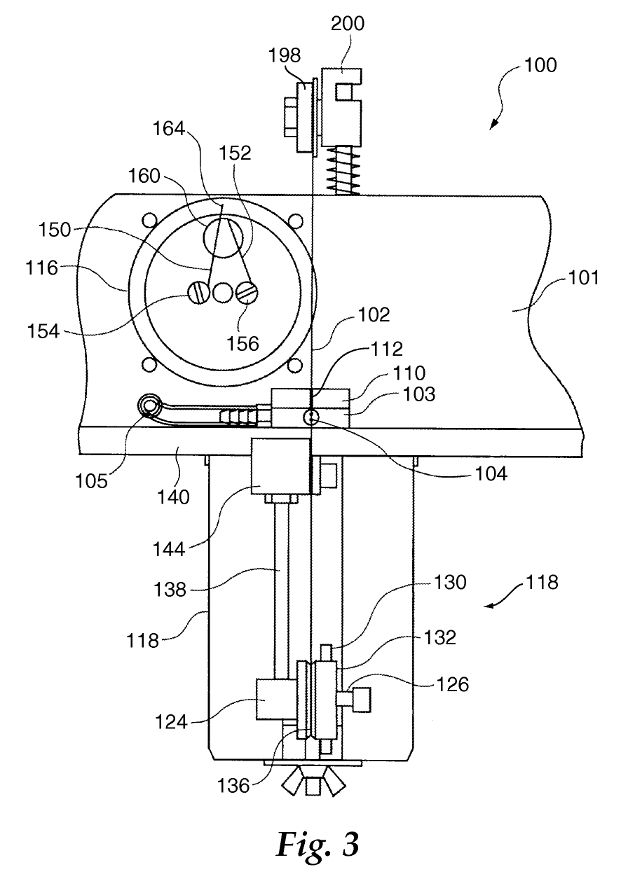

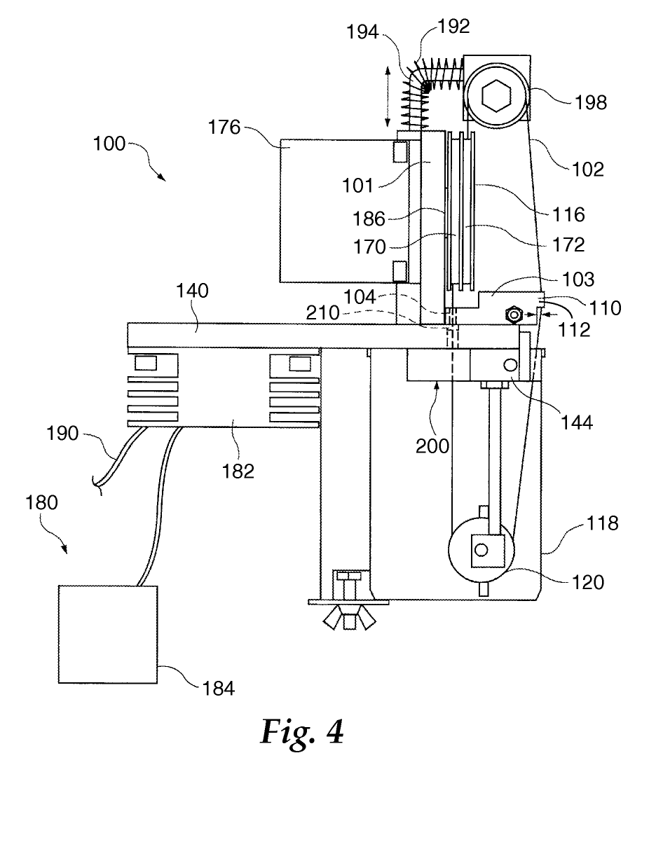

FIG. 3 is a front view of another embodiment of a fluid delivery system of the type described above, generally indicated at 100. FIG. 4 shows a side view of the fluid delivery system 100 of FIG. 3. Fluid delivery system 100 is preferably attached to a frame or plate 101 shown in partial view to which a plurality of such fluid delivery systems may be secured. Fluid delivery system 100 includes a wire 102 that preferably has wind and rewind capability and that is drawn in front of a nozzle body 103, and more specifically, in the path of an air stream emanating from a pair of nozzle orifices 104 defined in nozzle body 103.

An air supply hose 105 is secured to nozzle body 103 and supplies air through nozzle orifices 104. Nozzle orifices 104 are aimed at a segment of wire 102 passing thereby. A wire guide 110 (wire biasing idler) defining a longitudinal slot 112 is positioned proximate nozzle orifice 104. Wire 102 rides within longitudinal slot 112 and is thus held in relative position to nozzle orifices 104 so that air passing therethrough does not substantially move wire 102 from in front of the nozzle orifices 104 or cause the wire 102 to substantially vibrate.

In this embodiment, wire 102 is both advanced by and taken up by a single wheel 116. Wire 102 is fed from wheel 116 into a container or paint reservoir 118, at least partially around a rotatable or stationary idler or guide 120, past the nozzle orifices 104, through the wire guide 110, at least partially around a rotatable or stationary guide 198, and rewound upon the wheel 116. Guide 120 is comprised of a substantially cylindrical wheel rotatably attached to a base 124. Guide 120 is rotatable upon an axle 126, in this exemplary embodiment formed from a #10-32 socket head screw comprised of Teflon™ or Delrin™. Likewise, guide 120 may comprise a non-cylindrical, non-rotatable member having a groove or slot therein in which the elongate structure, in this embodiment a wire 102, can slide upon rotation of wheel 116. A plurality of projections or paddles 130 can be attached to or formed integral with a shaft 132 attached to guide 120. Paddles 130 mix the pigmented material contained in reservoir 134 as guide 120 rotates by movement of wire 102 through circumferential groove 136. Those skilled in the art will appreciate that paddles 130 may comprise fins or other protuberances or may be configured as slots or grooves in the surface of wheel 126 in order to create an irregular surface that causes mixing or stirring as guide 120 rotates.

Guide 120 is maintained in position within the reservoir 118 by an elongate member 138 depending from a frame or plate 140. Elongate member 138 is secured to plate 140 through a scrape attachment member, such as a doctor blade, 144. Guide 120 is secured to a distal end of elongate member 138.

Wire 102 is secured to the wheel 116 at both ends 150 and 152 with, for example, threaded fasteners 154 and 156, respectively, or other means known in the art. Wire 102 passes through a larger aperture 160 to the other side of wheel 116 and is wound onto wheel 116 from the feed end 152 of wire 102, around the various components of the paint delivery system 100, through a smaller aperture 164, and secured back to the wheel 116 at the take-up end 150. Preferably wire 102 is comprised of a single strand having a diameter of approximately 0.004 inch to about 0.020 inch, although wires of other dimensions may work equally as well, and is of a length that can be wrapped around the wheel 116 several times.

As can be seen in FIG. 4, which shows a side view of the paint injector system 100 of FIG. 3, wheel 116 defines two circumferential grooves 170 and 172. First circumferential groove 170 defines the feed side of wheel 116 while the groove 172 defines the take-up side. An electronically controllable drive mechanism, such as a motor 176, is employed to rotate the wheel 116 and thus advance the wire 102. Motor 176 may be a stepper motor, a servo motor, a DC motor, or other device known in the art in which rotational advancement of the wheel 116 can be selectively and/or incrementally controlled. Motor 176 is preferably electronically connected to and controlled by a processor or controller, generally indicated at 180, comprising an electronics module 182 and a signal generating device 184, such as a personal computer employing a microprocessor or other devices that can generate discrete signals to instruct selective rotation of shaft 186 of the motor 176. The circuitry of the electronics module 182 receives one or more signals from device 184 and rotates shaft 186 of the motor according the signal(s). Those skilled in the art will recognize that such circuitry could be incorporated into device 184 or that the components of device 184 could be incorporated into module 182.

In the case where motor 176 is a stepper motor, the signal(s) is sent in the form of one or more electrical pulses, each pulse designating a single step or a certain number of steps that the shaft 186 of the stepper motor 176 is to be rotated. A typical stepper motor provides 200 steps per revolution with each step being activated by a voltage that depends on the voltage requirement of the motor. Thus, if it is desired to deposit the quantity of paint drawn by the wire 102 in one half of a revolution of wheel 116, 100 pulses would be sent by device 184, module 182 would convert each pulse into a voltage depending on the voltage requirement of stepper motor 176 sufficient to cause stepper motor 176 to rotate its shaft 186 one step, and shaft 186 would rotate 100 steps.

A power supply line 190 may be connected to module 182 to provide the requisite voltage to turn the shaft 186 of motor 176. A preferred way of driving motor 176 is to perform all shaft 186 advances for fluid delivery system 100 by time calculations made by the device 184 thereby eliminating the need for a calculating device within fluid delivery system 100. Such time calculations may employ error diffusion, stochastic screening, or blue noise algorithms as are known in the art. Thus, all wire 102 advances for the same color of pigmented material, in addition to spatial motions of the fluid delivery system 100 relative to the print medium for depositing the metered pigmented material at relatively precise locations, can be made by the device 184 driving logic lines connected to the module 182 driving the motor 176. If a DC servo motor is employed, the signal sent from the device 184 would be converted into a voltage by the module 182 necessary to rotate the shaft 186 of the DC motor a desired portion of a rotation, and a feedback device, such as an optical encoder, would be employed by the module 182 to control the precise rotation. It is also contemplated that a crude metering of paint could be accomplished by simply providing a timed duration of power to a motor without feedback.

Wire 102 passes in front of nozzle body 103 and is held relative thereto by wire guide 110. As illustrated, wire guide 110 holds the wire a desired distance D, such as, for example, about 0.040 inch, from nozzle body 103 and thus the nozzle orifices 104. In addition, wire guide 110, in conjunction with a biased wire guide 198 keeps tension on wire 102 in front of the nozzle orifices by imparting a bend to the wire at wire guide 110 and thus holds the wire in relative position to the nozzle orifices.

By providing a rotatable wire biasing guide 198, wire tension on both sides of biasing guide 198 may be maintained on wire 102 as wire 102 is unwound and rewound onto wheel 116. This may prevent wire 102 from pulling down unequally on a biasing device (such as a spring, 192 and wire 102 from jumping out of biasing guide 198. Biasing guide 198 is important because the length of wire 102 extending between groove 170 and groove 172 will vary as wire 102 is wound and unwound between the two grooves 170 and 172. Guide 198 is secured to an elongated guide support member 194 preferably formed into a ninety-degree elbow configuration. As such, guide 198 is positioned to feed the wire 102 to near the center of groove 172. Of course, guide 198 may be positioned at other points along the path of wire 102 in order to maintain tension on wire 102. Support member 194 is secured to plate 101 in a manner that allows the support member 194 to move (e.g., slide) in directions indicated by the arrow. A biasing device 192, such as a coil spring positioned around the support member 194, is employed to bias guide 198 away from wheel 116. Accordingly, depending on the spring force of biasing device 192, a desired tension can be maintained in wire 102 during operation of fluid delivery system 100. Those skilled in the art will understand that other biasing devices or members and support structures may be employed to maintain tension in wire 102 during the course of operation of the device.

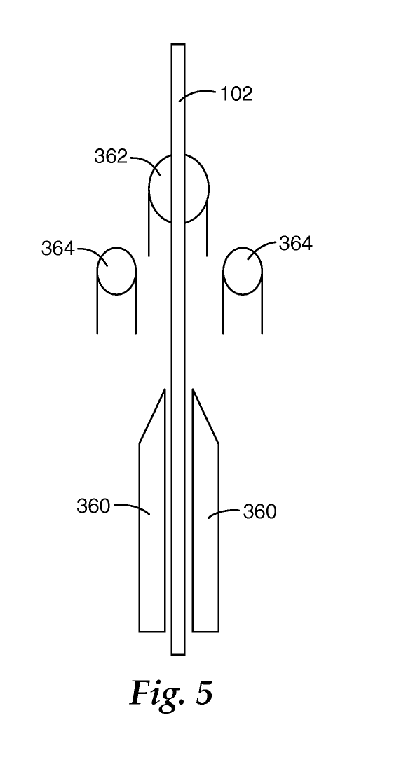

Of course, only a limited amount of wire 102 can necessarily be wound onto wheel 116. While it may be possible to provide enough wire 102 that one pass of the wire from groove 170 to groove 172 is sufficient to complete an entire printing application, it is more likely the case, especially for a print job of any substantial extent, that wire 102 will be required to be rewound into groove 170 during the course of printing. It is preferred that wire 102 be rewound after each pass of fluid delivery system 100 over the print medium. In a rewind cycle, a scraper device, such as a doctor blade, 200 provides secondary wiping of wire 102 as it passes through scraper device (or doctor blade) 200 and onto wheel 116 in groove 170. It is noted that while the scraper device 200 which provides both wiping of wire 102 when the wire is being advanced and wiping of the wire 102 when it is being rewound could be comprised of two separate scraping devices (or doctor blades). The secondary wiping of wire 102 is obviously important because wire 102 is recoated with pigmented material as it is drawn through the paint reservoir 118. A bore 204 provides a wire guide to align wire 102 with the groove 170. In addition, it is preferable that bore 204 be of a smaller size than a bore 206 such that a wiping device 210 is provided around wire 102 in bore 206. Wiping device 210 may be comprised, for example, of a string of material, such as dental floss, tied in a knot around wire 102 that is of a size that it cannot pass through bore 204 or through scraper device 200. Those skilled in the art will recognize that other wiping devices could be employed, such as sponges and other fabrics and materials that can substantially wipe any remaining pigmented material from the wire 102 or doctor blades that are positioned on opposite sides of wire 102, as are shown in FIG. 5. Wiping device 210 substantially removes the remaining pigmented material from wire 102 as it is rewound into the groove 170 in order to keep groove 170 substantially free of paint.

The print head in the fluid delivery systems of FIGS. 1-4 can include alternative implementations. For example, the print head can include a discontinuous wire and an air solenoid can be used to, for example, turn the air supply on and off or to keep the air supply constantly on.

FIG. 5 is a schematic view of another exemplary embodiment of a portion of a fluid delivery system. In this implementation, a set of two doctor blades 360 are positioned adjacent to cable 102. In some embodiments, each doctor blade 360 is spaced between about 0.01 inch and about 0.0001 inch from wire 102. In one preferred embodiment, used to prepare Examples 1-6, each doctor blade is spaced 0.001 inch from wire 102. FIG. 5 also shows orifice 362 through which fluid is projected to cause pigmented material on wire 102 to be transferred onto a print medium (not shown). Orifice 362 can be of a variety of diameters or shapes, can be located in a variety of positions, and can include a number of orifices preferably ranging from 1 to 100 in number, as will be understood by those of skill in the art, based on the desired graphics and printing effects. Orifice 362 shown in FIG. 5 (and used in the Examples below) is a center hole aligned with wire 102 and with two smaller diameter holes 364 aligned with orifice 362 in a pyramid shape. Exemplary orifices have a diameter that is between about 0.005 inch and about 0.05 inch. The exemplary embodiment shown in FIG. 5, and used in preparing Examples 1-6, includes an orifice 362 that has a diameter of 0.023 inch, and holes 364 that each have a diameter of 0.02 inch.

Cables 36 or 102 may include single or multiple strands of material. Exemplary materials from which cables 36 or 102 may be formed include, for example, stainless steel, spring metal, nickel/titanium alloy, and/or other metals and alloys; materials such as kevlar, graphite, nylon or other materials that are flexible and have a substantially high tensile strength. Cables 36 and 102 may include, for example, a steel music wire, a wire hoop, a loop as made from an endless cable or formed by photo etching techniques from flat sheet/shim stock, a band, a ribbon, or a relatively thin structure having material windable from a freely rotatable idler, spool or wheel onto a drive spool or wheel, or any other structure upon which liquified pigmented material could be applied.

The fluid delivery system uses a wire or cable to carry pigmented material from the reservoir to the fluid jet, which blows the pigmented material off the wire and onto the surface being coated. The quantity and quality of ink applied to the surface depends on the wire feed rate, rheological properties of the pigmented material, air flow, orifice geometry, and distance from the print head to the surface, among other things. The movement of the cable or wire relative to at least one fluid nozzle substantially controls the amount of pigmented material directed to the substrate and enables formation of a pattern on the substrate.

Other exemplary methods of applying ink to a print medium involve printing graphics at the desired resolution onto colored sheeting. The colored sheeting provides the background color, and the pigmented material printed onto the sheeting provides the graphics or indicia.

Other exemplary methods of applying ink to a print medium involve the use of more than one color of ink. These methods can be used, for example, to change the color of the final image, to create an image with multiple colors, or to shade portions of the image with different colored inks. The use of multiple colors of ink includes using a single color of ink and a transparent ink layer as well as using two or more inks that each are colored and are of a different color.

Other exemplary methods of applying ink to a print medium involve printing graphics using a single layer of ink or using multiple layers of ink. These varying methods provide for different effects, including, among others, changing the color density of the ink on the substrate (e.g., increasing the darkness of the color); creating a pattern (e.g., checkerboard) on the substrate; or mixing colors on the substrate to achieve a final image that is a combination of the two colors used (e.g., coating a portion of the sheeting with red ink and then while the red ink is wet, coating at least a portion of the red ink with yellow ink to create generally orange image effects in locations where the two inks were used).

To achieve good image quality, the printed ink drops must spread to within an acceptable range in order to provide a desirable degree of solid fill. If the ink drops do not spread to the desired range, unfilled areas will contribute to reduced color density and will result in banding effects (i.e., gaps between the rows of ink drops). On the other hand, if the ink drops spread too much, loss of resolution and poor edge acuity is evident, and inter-color bleed occurs in the case of multi-color graphics. The image quality can be qualitatively expressed with reference to color density and with regard to final ink dot diameter, as is described in U.S. Pat. No. 4,914,451. The fluid delivery system can provide overspray of the ink, which can be undesirable for certain uses of the system in that the overspray may provide ink where it is not required. When a pixel is meant to be printed, the wire is forwarded to pull the ink out of the doctor blades and in front of the orifice. When the system is instructed to stop printing, the wire is stopped. In one embodiment, the air flows out of the orifice at all times during the printing process, the main effect of which produces most of the overspray on a printed line by ink moving on the wire. Simply stopping the wire does not stop the ink from moving in front of the orifice. This effect is due to either the ink trickling back down from the wire above the orifice due to gravity, or the ink getting pulled out of the doctor blades back up the wire due to the venturi effect and cohesion of the ink.

One prior art method to minimize the incidence of this potentially undesirable effect involves using absorbent materials as the print medium to minimize the incidence of splattering, splashing, or overspraying of ink. However, some of the preferred print mediums for printing on signage are non-absorbent. Consequently, the inventors of present application fine-tuned the operational parameters of the fluid delivery system, the ink viscosity and percent solids, and the properties of the desired print mediums to create a system that allows for high resolution images to be printed on non-absorbent materials using the type of fluid delivery systems described above.

The printer is uniquely qualified to print high viscosity inks or inks that have a high percent solids due to the fact that, among other things, the ink does not pass through an orifice. In particular, the fluid delivery system can print inks that have a viscosity too low for conventional screen printing and a viscosity too high for conventional ink jet printing. In addition, the fluid delivery system can print inks that have a particle size too great for both conventional ink jet printing or screen printing. The maximum viscosity of an ink for ink jet printing is typically 20 centipoise (cP) at approximately 25 degrees Celsius, and the maximum particle size for ink jet ink printing is typically 1-2 microns. Screen print inks typically require a viscosity greater than 800 cP at approximately 25 degrees Celsius, and screen printing can typically print inks with particle sizes up to 125 microns. In comparison, the fluid delivery system can print inks having a viscosity between 1 cP and 2000 cP at ambient or room temperature, in addition to having the capability to print inks having a particle size between about 0 microns and about 600 microns.

A list of exemplary commercially available inks that fall within this range includes: 3M Process Color Series 700, 3M Process Color Series 880-00, 3M Process Color Series 880i, 3M Process Color Series 990, 3M Scotchlite Transparent Screen Printing Ink Series 2900, 3M Screen Printing Ink Series 1900, 3M Screen Printing Ink Series 9700UV, Nazdar 3500 Series UV Vinex Screen Ink, Avery Dennison Series 4930 Series Inks (10 year-1 Component Solvent Ink*), Sericol UVTS Series Ink, Nazdar UVTS Series Ink, Avery Dennison® UVTS-Sericol Ultraviolet Curable Printing Inks, Avery Dennison® UVTS-NazDar Ultraviolet Curable Printing Inks, Kiwalite KT Series Screen Process Ink, Avery Dennison® 10TS SeriesTwo-Component Printing Inks For Traffic Sign Products, Sericol Sinvacure UV Curable Screen Ink, Avery Dennison® 7TS Series Inks One Component Solvent Ink System For Traffic Sign Products, and Ink Dezyne VP-000 Series Vinyl Plus Screen Ink.

The image that can be formed on a substrate to form signage can be any type of image, including, for example, words, letters, symbols, pictures, schematics, numbers, a pattern, and combinations or variations thereof. The images can be clear, transparent, or opaque, and the pigmented material can thus also be clear, transparent, or opaque. Further, the substrate and image may be colorless, comprise a solid color, or comprise a pattern of colors. Additionally, the substrate and image may be transmissive, reflective, non-reflective, or retroreflective.

The following examples describe the construction of some exemplary signage using a fluid delivery system of the type described above. The following examples also report some of the physical properties of the signage.

Examples 1-6 were conducted using the apparatus of FIG. 3 and 4 using the orifices and doctor blades shown in FIG. 5 and using the WireJet® TC (Tri-Color) software version 4.8.0. The wire diameter used for all Examples was 0.008 inch. Table I describes the operational parameters used for each of Examples 1-6.

TABLE I
Operational Parameters for Examples 1-6

| | Ex. 1 | Ex. 2 | Ex. 3 | Ex. 4 | Ex. 5 | Ex. 6 |
|---|---|---|---|---|---|---|
| Air pressure^{∞} | 18 | 16 | 22 | 22 | 22 | 22 |
| (psi) | | | | | | |
| Distance from | 0.25 | 0.25 | 0.25 | 0.25 | 0.25 | 0.25 |
| Substrate § | | | | | | |
| (inches) | | | | | | |
| Doctor Blade | 10 | 10 | 10 | 10 | 10 | 10 |
| Spacing^{Σ} | | | | | | |
| (mils) | | | | | | |
| Air solenoid^{ψ} | Absent | Absent | Absent | Absent | Present | Present |
| Paint | 1500 | 2000 | 2000 | 2000 | 2000 | 2000 |
| Injection^{Φ} | | | | | | |
| (number of | | | | | | |
| pulses) | | | | | | |
| Print Line | 0.04 | 0.03 | 0.03 | 0.03 | 0.03 | 0.02 |
| Separation | | | | | | |
| (inches) | | | | | | |

^{∞}“Air pressure” refers to the regulated air pressure applied to the orifice.
§ “Distance from Substrate” refers to the distance between the wire and the print medium.
^{Σ}“Doctor Blade Spacing” refers to the total spacing between the two halves of the doctor blades and the wire, and determines the size of the gap between the edges of the doctor blades and the wire.
^{ψ}“Air solenoid” “Present” refers to a fluid delivery system including an air solenoid that blows air when the wire is moving and does not blow air when the wire is not moving. whether the air was on or off during movement of the wire. “Air Solenoid” “Absent” refers to the fact that no air solenoid was in the fluid delivery system.
^{Φ}“Paint injection” refers to a parameter used to calculate the number of pulses generated by the computer to cause the wire to move one inch. Paint injection directly correlates to the amount of wire moved per pulse, such an increase in paint injection correlates to an increased amount of wire moved per pulse, and a decreased paint injection correlates to a decreased amount of wire moved per pulse.
“Print line separation” refers to the distance the print head shifts between adjacent printed lines. Print line separation affects the coverage of the ink on the substrate.

### EXAMPLE 1

A piece of white sheeting commercially available from 3M under the trade name 3M™ Diamond Grade™ VIP Reflective Sheeting Series 3990 (hereinafter referred to as “3990 sheeting”) that measured 9 inches from left to right (hereinafter referred to as “width” or “wide”) and 11 inches from top to bottom (hereinafter referred to as “length” or “long”) was cut. Green ink commercially available from 3M Company, St. Paul, Minn. under the trade name 3M™ 8881 Green Process Color was diluted with Methyl Ethyl Ketone (MEK) using (by volume) one part 3M™ 8881 Green Process Color to one part MEK. The viscosity of the 3M™ 8881 Green Process Color is approximately 1000-1200 cP at approximately 25 degrees Celsius measured using a Brookfield synchro-lectric viscometer model HATwere. The percent solids of the 3M™ 8881 Green Process Color is approximately 30-41%. The viscosity and percent solids of the 3M™ 8881 Green Process Color diluted with MEK as per Example 1 were 100 cP (measured as described above) and approximately 15-21%, respectively.

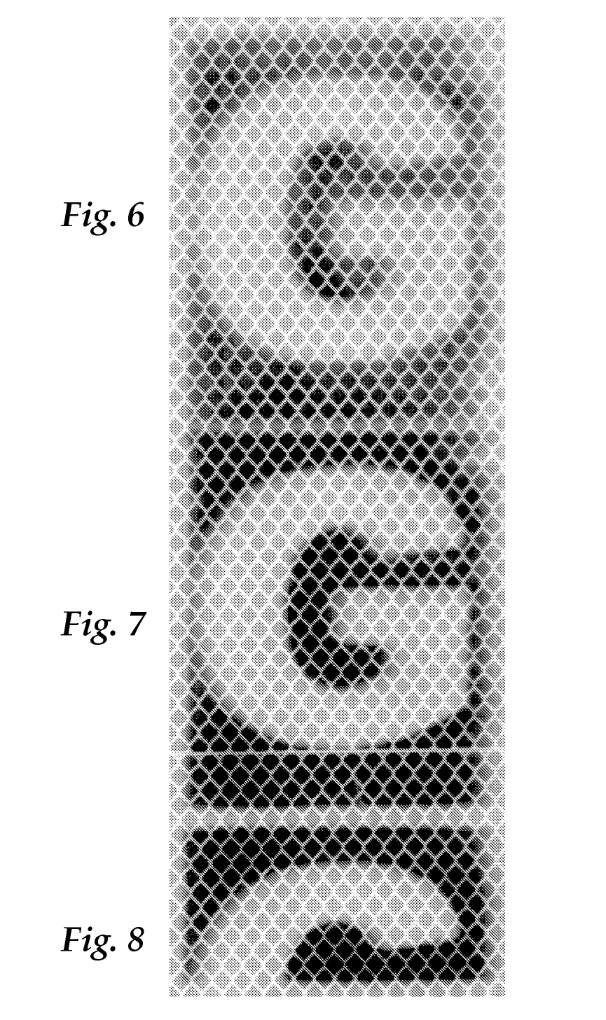

The apparatus described above operating at the operational parameters described in Table I was used to form an image on the 3990 sheeting. One layer of the ink was printed on the 3990 sheeting. A scanned image of the image that was formed on the sheeting in Example 1 is shown in FIG. 6. The image can be described as a “reverse” image in that the ink (3M™ 8881 Green Process Color) was used to print the background (in the instant case, a green background) and to thereby create an image (in the instant case, the letter “G”) that is the same color as the sheeting (in the instant case, white). The total size of the image was 2.75 inches wide by 2.4 inches long. The size of the letter “G” was 2.4 inches wide by 2.56 inches long.

### EXAMPLE 2

Example 2 was conducted as described for Example 1, except that some of the operational parameters of the fluid delivery system differed as described in Table 1. A scanned image of the image that was formed on the sheeting in Example 2 is shown in FIG. 7.

### EXAMPLE 3

Example 3 was conducted as described for Example 1, except that some of the operational parameters of the fluid delivery system differed as described in Table 1. A scanned image of the image that was formed in Example 3 is shown in FIG. 8. The image that was formed on the sheeting was not the entire “G” but a top portion of the “G,” as is shown in FIG. 8.

### EXAMPLE 4

A piece of white 3990 sheeting that measured 24 inches wide by 10 inches long was cut. Green ink commercially available from 3M Company, St. Paul, Minn. under the trade name 3M™ 8881 Green Process Color was diluted with Methyl Ethyl Ketone (MEK) using (by volume) one part 3M™ 8881 Green Process Color to one part MEK. The viscosity and percent solids for these solutions were as reported above in Example 1.

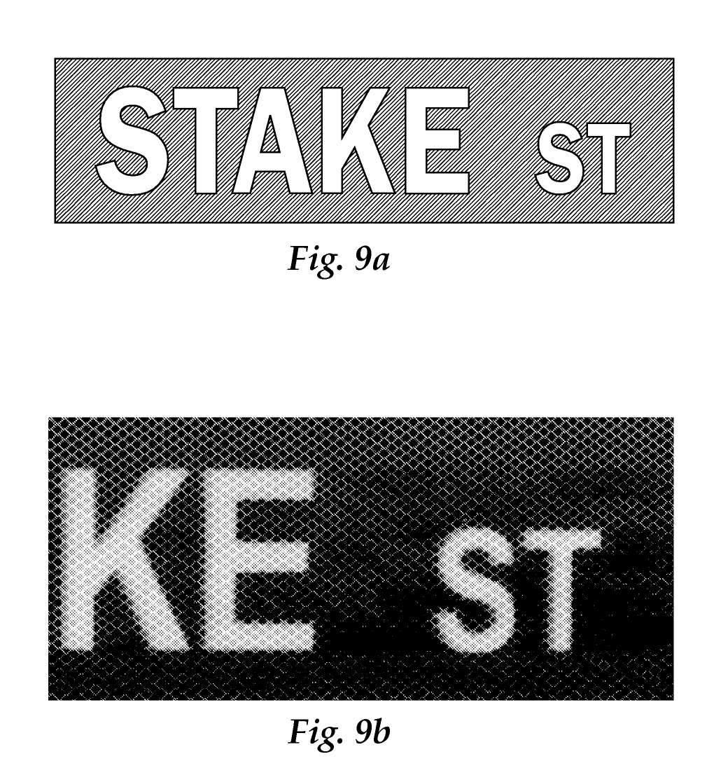

The apparatus described above operating at the operational parameters described in Table I was used to form an image on the 3990 sheeting. One layer of ink was printed on the 3990 sheeting. A schematic view of the image formed on the 3990 sheeting is shown in FIG. 9a. The image is commonly described as a “reverse” image in that the ink (3M™ 8881 Green Process Color) was used to print the background (in the instant case, a green background) and to thereby create an image (in the instant case, the words “STAKE ST” that is the same color as the sheeting (in the instant case, white). The size of the image was 6 inches wide and 22 inches long. The size of the “STAKE” portion of the image was 11.6 inches wide by 3.25 inches long and the size of the “ST” portion of the image was 2.8 inches wide by 2.2 inches long. Following printing and drying, the printed sheet was cut using scissors to obtain the desired final signage size of 20.75 inches wide and 5.4 inches long. A scanned image of a part of the image that was formed on the sheeting in Example 4 is shown in FIG. 9b.

### EXAMPLE 5

A piece of white 3990 sheeting that measured 17.8 inch wide by 5.6 inch long was cut. Green ink commercially available from 3M Company, St. Paul, Minn. under the trade name 3M™ 8881 Green Process Color was diluted with Methyl Ethyl Ketone (MEK) using (by volume) one part 3M™ 8881 Green Process Color to one part MEK. The viscosity and percent solids for these solutions were as reported in Example 1.

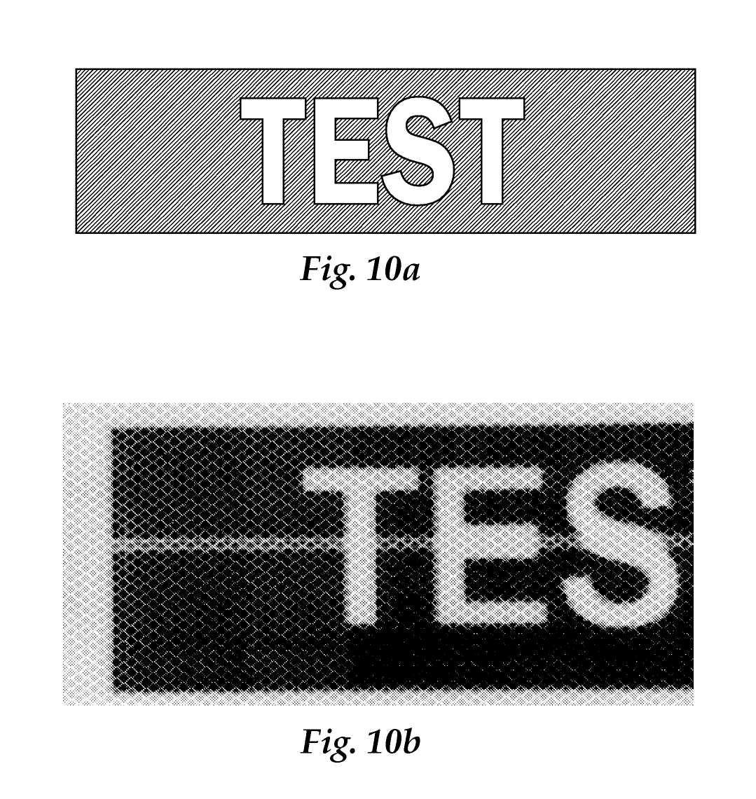

The apparatus described above operating at the operational parameters described in Table I was used to form an image on the 3990 sheeting. One layer of the ink was printed on the 3990 sheeting. A schematic view of the image formed on the 3990 sheeting is shown in FIG. 10a. The image is commonly described as a “reverse” image in that the ink (3M™ 8881 Green Process Color) was used to print the background (in the instant case, a green background) and to thereby create an image (in the instant case, the words “TEST” that is the same color as the sheeting (in the instant case, white). The size of the image was 16 inches wide by 4.75 inches long. The size of the “TEST” portion of the image was 8.75 inches wide by 2.75 inches long. A scanned image of a part of the image that was formed on the sheeting in Example 5 is shown in FIG. 10b.

### EXAMPLE 6

A piece of yellow sheeting commercially available from 3M under the trade name 3M™ Diamond Grade™ VIP Reflective Sheeting Series 3991 (hereinafter referred to as “3991 sheeting”) that measured 30 inches wide by 18 inches long was cut. Black ink commercially available from 3M under the trade name 3M™ 885N Black Process Color was diluted with MEK using (by volume) one part ink to one part MEK. The viscosity of the 3M™ 885N Black Process Color is approximately 1000-1200 cP at approximately 25 degrees Celsius and the viscosity of the sample used in Example 1 was 1840 cP at approximately 25 degrees Celsius measured using a Brookfield synchro-lectric viscometer model HATware. The percent solids of the 3M™ 885N Black Process Color was approximately 33-35%. The viscosity and percent solids of the 3M™ 885N Black Process Color diluted with MEK were 40 cP measured using a Brookefield synchro-lectric viscometer model HAT at approximately 25 degrees Celsius and and approximately 16-18%, respectively.

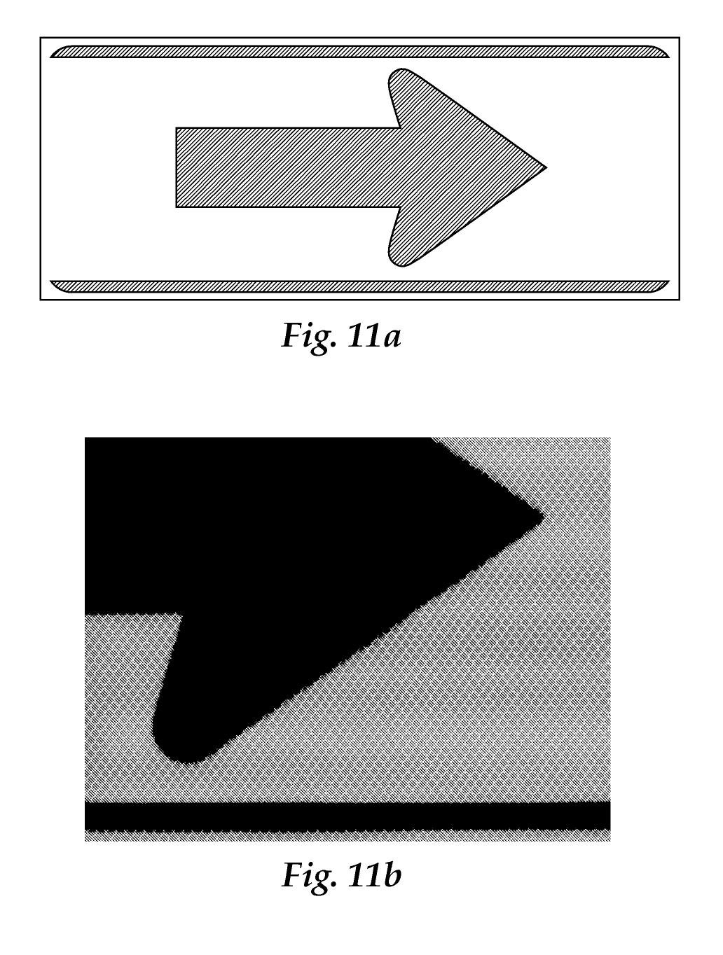

The apparatus described above operating at the operational parameters described in Table I was used to form an image on the 3991 sheeting. One layer of the ink was printed on the 3991 sheeting. A schematic view of the image formed on the 3991 sheeting is shown in FIG. 11a. The image printed on the yellow sheeting was a black arrow in which the black ink was used to print the image of the arrow as well as the horizontal line border above and below the arrow. The tip to tail measurement of the arrow was 20 inches left to right and 3.5 inches top to bottom. The blade of the arrow measured from left to right was 7.5 inches and from wingtip to wingtip (top to bottom) was 9.5 inches. A black line, measuring 0.5 inch top to bottom and 24 inches left to right, was printed 1 inch from both the top and bottom borders of what would be the cropped sheeting having the measurements of 26 inches wide and 14.2 inches long. A scanned image of a part of the image that was formed on the sheeting in Example 6 is shown in FIG. 11b.

The printed sheeting formed in Examples 1-6 was visually inspected by holding the sheeting at arm's length and noting the contrast of the inked areas to the unprinted sheeting.

Comparing the signages formed in Examples 1-3, three variables changed between Examples 1 and 2: the air pressure was decreased; the paint injection parameter was increased; and the print line separation was decreased. Visually, the signage produced in Example 2 exhibited more saturated color and less overspray compared to the signage produced in Example 1. The only parameter that changed between Example 2 and Example 3 was that the air pressure was increased. Visual review of the signage formed in Example 3 showed that the signage prepared in Example 3 exhibited higher contrast, better edge definition, and a more uniform texture or fill with no visibly discrete lines.

The operational parameters used in Example 4 were the same as those used in Example 3. However, Example 4 involved the preparation of a larger sized signage of the type capable for use as a street sign. The results of Example 4 showed that a street sign could be made that exhibited high contrast, good edge definition, and uniform texture.

The operational parameters used in Example 5 were the same as those used in Example 4 except that a solenoid was used such that the air was on when the wire was moving and the air was off when the wire was not moving in front of the orifice. A visual inspection of the signage formed in Example 5 suggests that signage made using an air solenoid exhibits improved edge quality as compared to the signage formed in Examples 3 and 4.

The signage formed in Example 6 involved the use of a different ink and a different substrate or print medium. Further, Example 6 was made with the image itself printed on the sheeting (rather than printing the background onto the sheeting). The only operational parameter that changed between Example 5 and Example 6 is the print line separation. Visual inspection of the signage of Example 6 showed improved edge quality compared to the sign formed in Example 5. With the background unprinted and the arrow image printed, the sign of Example 6 was similar to a sign produced for roadway marking by sign makers in the industry.

Depending on, among other things, the pigmented material and the substrate, the various types of signage that can be made using the methods and printed using the fluid delivery systems described above are “durable for outdoor use,” which refers to the ability of the signage article to withstand temperature extremes, exposure to moisture ranging from dew to rainstorms, and colorfast stability under sunlight's ultraviolet radiation. The threshold of durability is dependent upon the conditions to which the signage article is likely to be exposed and thus can vary. At minimum, however, the signage articles of the present application do not delaminate or deteriorate when submersed in ambient temperature (25° C.) water for 24 hours, nor when exposed to temperatures (wet or dry) ranging from about −40° C. to about 140° F. (60° C.).

In the case of signage for traffic control, signage articles are preferably sufficiently durable such that the articles are able to withstand at least one year and more preferably at least three years of weathering. This can be determined, at least in part, with ASTM D4956-05 Standard Specification of Retroreflective Sheeting for Traffic Control that describes the application-dependent minimum performance requirements, both initially and following accelerated outdoor weathering, of several types of retroreflective sheeting. Initially, the reflective substrate meets or exceeds the minimum coefficient of retroreflection. For Type I white sheetings (“engineering grade”), the minimum coefficient of retroreflection is 70 cd/fc/ft² at an observation angle of 0.2⁰ and an entrance angle of −4⁰, whereas for Type III white sheetings (“high intensity”) the minimum coefficient of retroreflection is 250 cd/fc/ft² at an observation angle of 0.2⁰ and an entrance angle of −4⁰. Further, for Type IX white sheetings, the minimum coefficient of retroreflection is 380

cd/fc/ft² at an observation angle of 0.2⁰ and an entrance angle of −4⁰. In addition, minimum specifications for shrinkage, flexibility, adhesion, impact resistance and gloss are preferably met. After accelerated outdoor weathering for 12, 24, or 36 months, depending on the sheeting type, ink type, and application, the retroreflective sheeting preferably shows no appreciable cracking, scaling, pitting, blistering, edge lifting or curling, or more than 0.8 millimeters shrinkage or expansion following the specified testing period. In addition, the weathered retroreflective articles preferably exhibit at least the minimum coefficient of retroreflection and colorfastness. For example, Type I “engineering grade” retroreflective sheeting intended for permanent signing applications retains at least 50% of the initial minimum coefficient of retroreflection after 24 months of outdoor weathering and Type III and IX “high intensity” type retroreflective sheeting intended for permanent signing applications retains at least 80% of the initial minimum coefficient of retroreflection following 36 months of outdoor weathering in order to meet the specification. The target values for the initial and weathered coefficient of retroreflection values for colored sheeting is described in ASTM-D4956-05.

With respect to the durability of the inks printed on sheeting, inks must meet stringent performance requirements in order for the inks to be appropriately digitally printable and for the resultant printed features to have the desired mechanical, chemical, visual, and durability characteristics. The outdoor durability of an ink or digitally printed image typically correlates to the weight average molecular weight (Mw) of the binder as well as the concentration of the binder in the ink. Compositions comprising low molecular weight binder(s) and/or relatively low concentration of binder(s) are typically less durable than compositions comprising a higher concentration of binder and/or higher molecular weight polymers. In some embodiments, enhanced durability for outdoor usage can result when both the primer composition and ink composition are aliphatic, being substantially free of aromatic ingredients. Further, inks preferably have a viscosity that permits their application to the sheeting in the desired resolution yet enables formation of accurate, durable images on the desired substrate.

Various modifications and alterations of the present invention will become apparent to those skilled in the art without departing from the spirit and scope of the invention.

What is claimed is:

1. A method of forming an image on a signage, comprising:
applying a pigmented material to at least a portion of an elongate structure;
positioning the elongate structure in proximity to a substrate; and
directing a fluid stream at the portion of the elongate structure to which the pigmented material was applied such that at least a portion of the pigmented material is deposited onto the substrate to thereby form the signage.

2. The method of claim 1, further including electronically controlling advancement of the elongate structure.

3. The method of claim 1, further including digitally controlling advancement of the elongate structure.

4. The method of claim 1, in which the signage is one of a sign or a license plate.

5. The method of claim 4, in which the signage is capable of outdoor use.

6. The method of claim 1, in which the elongate structure is one of a wire, a cable, a rope, a cord, a string, a strand, a rod, a saw tooth wheel, two or more of any of the above, or combinations or variations thereof.

7. The method of claim 1, in which the pigmented material is a colored or non-colored ink, dye, paint, or combination or variation thereof.

8. The method of claim 1, in which the pigmented material has a viscosity between about 1 cP and about 2000 cP at ambient temperature.

9. The method of claim 1, in which the fluid stream comprises air.

10. The method of claim 1, in which the pigmented material has a percent solids that is less than 50%

11. The method of claim 1, in which the pigmented material has a particle size that is less than about 600 microns.

12. The method of claim 1, in which multiple pigmented materials are applied to the substrate.

13. A signage formed by the method of claim 1.

14. A method of digital printing to form an image on a signage, comprising:
coating at least a portion of a wire-like member with a pigmented material;
positioning the wire-like member in proximity to a substrate; and
directing a fluid stream at the coated portion of the wire-like member such that at least a portion of the pigmented material is removed from the wire-like structure and is deposited onto the substrate to thereby form a pattern on the substrate.

15. The method of claim 14, in which the pattern includes at least one of a word, a letter, a symbol, a picture, a schematic, an image, a number, or a combination or variation thereof.

16. The method of claim 14, in which the pigmented material has a viscosity between about 1 cP and about 2000 cP at ambient temperature.

17. The method of claim 14, in which the pigmented material has a viscosity of between about 25 cP and about 800 cP at ambient temperature.

18. The method of claim 14, in which the pigmented material has a particle size of less than about 600 microns.

19. A signage formed by the method of claim 14.

20. A signage, comprising:
an optically active sheeting; and
a pigmented material having a viscosity of between about 25 cP and about 2000 cP at ambient temperature that is digitally printed on at least a portion of the sheeting to form an image.
